(19) United States
(12) Patent Application Publication
(10) Pub. No.: US 2014/0104408 A1
(43) Pub. Date: Apr. 17, 2014

(54) VEHICLE DRIVING ASSISTANCE SYSTEM USING IMAGE INFORMATION

(71) Applicant: DENSO CORPORATION, Kariya-city (JP)

(72) Inventor: Hideaki NANBA, Obu-shi (JP)

(73) Assignee: DENSO CORPORATION, Kariya-city (JP)

(21) Appl. No.: 14/054,888

(22) Filed: Oct. 16, 2013

(30) Foreign Application Priority Data
Oct. 17, 2012 (JP) 2012-230108

(51) Int. Cl. G08G 1/16; G06K 9/00; H04N 7/18

(52) U.S. Cl. CPC G08G 1/164; H04N 7/185; G06K 9/00805
USPC 348/119

(57) ABSTRACT

A vehicle driving assistance system not using a high performance computer mounted in a vehicle. In the system, an imaging unit mounted in the vehicle captures an image of surroundings of the vehicle. A communication unit mounted in the vehicle transmits information including the image captured by the imaging unit to an information processing center outside of the vehicle. An image processing unit included in the information processing center applies predefined image processing to the image received from the vehicle. A communication unit included in the information processing center transmits information indicative of an outcome of the image processing by the image processing unit to the vehicle. A driving assistance unit mounted in the vehicle performs operations for assisting in driving the vehicle on the basis of the information indicative of the outcome of the image processing by the image processing unit.

### CROSS-REFERENCE TO RELATED APPLICATION

This application is based on and claims the benefit of priority from earlier Japanese Patent Application No. 2012-230108 filed Oct. 17, 2012, the description of which is incorporated herein by reference.

### BACKGROUND

1. Technical Field

The present invention relates to a vehicle driving assistance system using image information.

2. Related Art

Known driving assistance systems as disclosed in Japanese Patent Application Laid-Open Publication No. 2010-15248 and Japanese Patent Application Laid-Open Publication No. 2011-253214 process an image of surroundings of a subject vehicle captured by a vehicle-mounted camera to detect an object, such as a pedestrian or the like, and present the detection of the object to a driver of the vehicle to draw attention to the driver in support of safe driving.

The known systems as described above are adapted to, for example, upon detection of the pedestrian that is an object to be detected, match the captured image with a pattern image indicative of the presence of a pedestrian. The system disclosed in Japanese Patent Application Laid-Open Publication No. 2010-15248 applies frequency analysis to a distribution of sum values of respective lines of pixels along a predetermined direction in a candidate image extracted through the pattern matching. When it is detected in the frequency analysis that a power spectral density of a predefined frequency exceeds a predetermined threshold value, the captured image is assumed to include the pedestrian, which prevents a false detection of the pedestrian during the pattern matching. In addition, the system disclosed in Japanese Patent Application Laid-Open Publication No. 2011-253214, while ensuring accuracy of detecting the pedestrian through the pattern matching, changes a searching density in searching for the pedestrian in the captured image as a function of a traffic condition to reduce an amount of computation required in the image processing. Besides the above systems, there have been proposed so far various techniques for enhancing accuracy of detecting an object and/or reducing an amount of computation.

The known systems as described above, however, are adapted to process the captured image by using a vehicle-mounted computer. Detecting the object accurately through the image processing using the vehicle-mounted computer requires a high processing speed and a high memory capacity for the computer. This leads to a more expensive system, which prevents the proliferation of such a system.

In consideration of the foregoing, it would therefore be desirable to have a vehicle driving assistance system capable of applying image processing to a captured image to assist a driver in driving a vehicle without using a high performance vehicle-mounted computer.

### SUMMARY

In accordance with an exemplary embodiment of the present invention, there is provided a vehicle driving assistance system including: an imaging unit mounted in a vehicle and configured to capture an image of surroundings of the vehicle; a vehicle-side communication unit mounted in the vehicle and configured to transmit information including the image captured by the imaging unit to an information processing center outside of the vehicle; an image processing unit included in the information processing center and configured to apply predefined image processing to the image received from the vehicle; a center-side communication unit included in the information processing center and configured to transmit information indicative of an outcome of the image processing by the image processing unit to the vehicle; and a driving assistance unit mounted in the vehicle and configured to perform operations for assisting in driving the vehicle on the basis of the information indicative of the outcome of the image processing by the image processing unit.

In the system configured as above, the image processing is performed not in a computer mounted in the vehicle, but in the information processing center outside of the vehicle. Hence, only transmission of the information including the image to the information processing center and operations for assistance in driving the vehicle on the basis of the outcome of the image processing received from the information processing center have to be performed on the vehicle side.

The present invention is owing to recent rapid development of communication networks. In general, information including an image is accompanied with a large amount of data. The recent development of the communication networks allows such a large amount of data to be communicated at high rates. In addition, a high-performance computer may be installed in the information processing center without difficulty. Image processing using such a high-performance computer leads to higher accuracy of detecting an object that is an obstacle to vehicle driving. This allows practical assistance in driving the vehicle to be performed without using such a high-performance computer on the vehicle side.

Preferably, the system may further include: a congestion status detection unit included in the information processing center and configured to detect a congestion status of a communication network between the vehicle-side communication unit and the center-side communication unit; and a transmission control unit mounted in the vehicle and configured to select a data amount reduction process to be applied to the information to be transmitted by the vehicle-side communication unit and a transmission frequency at which the processed information is to be transmitted as a function of the congestion status of the communication network detected by the congestion status detection unit.

When the information including the image is transmitted from the vehicle to the information processing center, a communication rate may vary depending on a congestion status of the communication network between the vehicle-side communication unit and the center-side communication unit. For example, a greater time period may be required to complete the transmission of the information for a worsening congestion status of the communication network. Meanwhile a sequence of operations to assist in driving the vehicle on the basis of the information including the image of surroundings of the vehicle has to be performed without delay.

Hence, preferably, contents and/or a transmission frequency (or a transmission time interval) of the information to be transmitted from the vehicle-side communication unit to the information processing center may be changed as a function of the congestion status of the communication network. This allows a data amount of information to be transmitted to be changed depending on the congestion status of the communication network, thereby preventing the sequence of operations to assist in driving the vehicle from being delayed by the transmission of the information.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

In the accompanying drawings:

FIG. 1A shows a block diagram of a vehicle driving assistance system in accordance with a first embodiment of the present invention;

FIG. 1B shows a functional block diagram of a controller of a vehicle-mounted apparatus in accordance with the first embodiment;

FIG. 1C shows a functional block diagram of a computer of an image information processing center in accordance with the first embodiment;

FIG. 2 shows a flowchart of a process of selecting a data amount reduction process to be applied to images to be transmitted and their transmission frequency in accordance with the first embodiment;

FIG. 3 shows a flowchart of a data amount reduction process performed in the vehicle-mounted apparatus in accordance with the first embodiment;

FIG. 4 shows a flowchart of a process where the vehicle-mounted apparatus transmits the images to the image information processing center in accordance with a determination of the process of FIG. 2;

FIG. 5 shows a flowchart of a process, performed in a vehicle-mounted apparatus, of alerting a vehicle driver when a vehicle is at high risk of colliding with an object in accordance with the first embodiment;

FIG. 6 shows a flowchart of a process performed in the image information processing center in accordance with the first embodiment;

FIG. 7 shows a flowchart of a collision risk determination process of FIG. 6;

FIG. 8 shows an example of calculating a distance from a vehicle to an object for determining a collision risk in accordance with the first embodiment;

FIG. 9A shows a functional block diagram of a controller of a vehicle-mounted apparatus in accordance with a second embodiment of the present invention;

FIG. 9B shows a functional block diagram of a computer of an image information processing center in accordance with the second embodiment;

FIG. 10 shows a flowchart of a process of selecting a data amount reduction process to be applied to images to be transmitted and their transmission frequency in accordance with the second embodiment; and

FIG. 11 shows a flowchart of a process performed in the image information processing center in accordance with the second embodiment.

### DESCRIPTION OF SPECIFIC EMBODIMENTS

### First Embodiment

A vehicle driving assistance system in accordance with a first embodiment of the present invention will be described more fully hereinafter with reference to the accompanying drawings. In the present embodiment, the vehicle driving assistance system is adapted to applications in which a collision risk with an object, such as a vehicle (including a motorcycle) or a pedestrian ahead of the subject vehicle, is determined, and the determined collision risk is then presented to a driver of the subject vehicle.

The vehicle driving assistance system of the present embodiment, as will be described later, is configured such that a vehicle-mounted apparatus 10 transmits information including an image to an image information processing center 20 outside of the subject vehicle, the image information processing center 20 applies predefined image processing to the received image, and the vehicle-mounted apparatus 10 assists in driving the subject vehicle on the basis of an outcome of the image processing. The present invention is therefore applicable to any vehicle driving assistance system that assists in vehicle driving based on image processing. The vehicle driving assistance system of the present invention may, for example, be adapted to applications in which the vehicle-mounted apparatus 10 captures an image of surroundings of the subject vehicle and the image information processing center 20 in turn converts the captured image into a bird's-eye view image to present the converted image to the driver of the subject vehicle or recognizes a parking slot on the basis of the captured image to navigate the subject vehicle to the parking slot in an automatic manner.

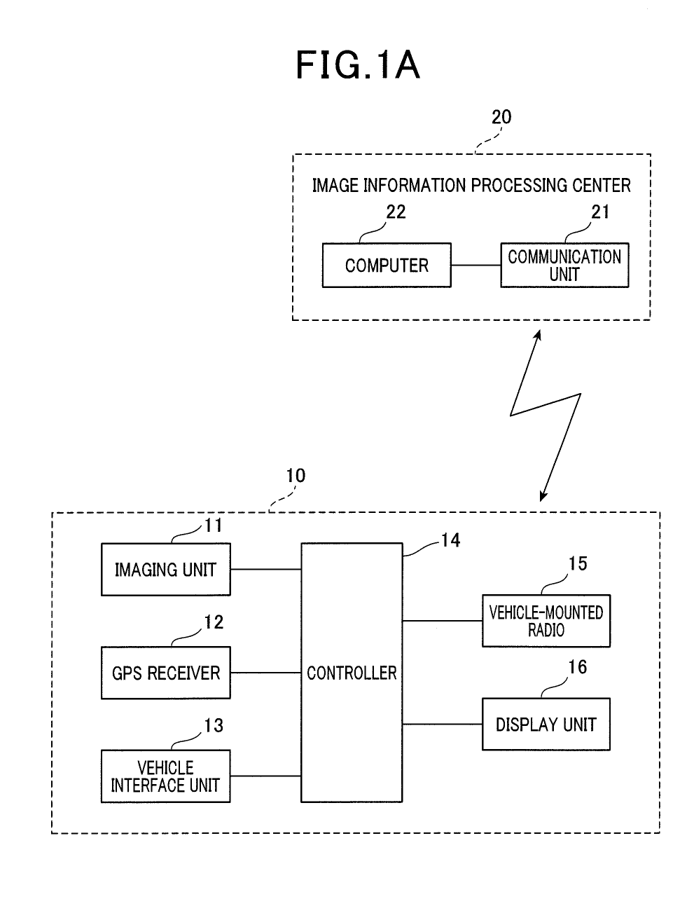

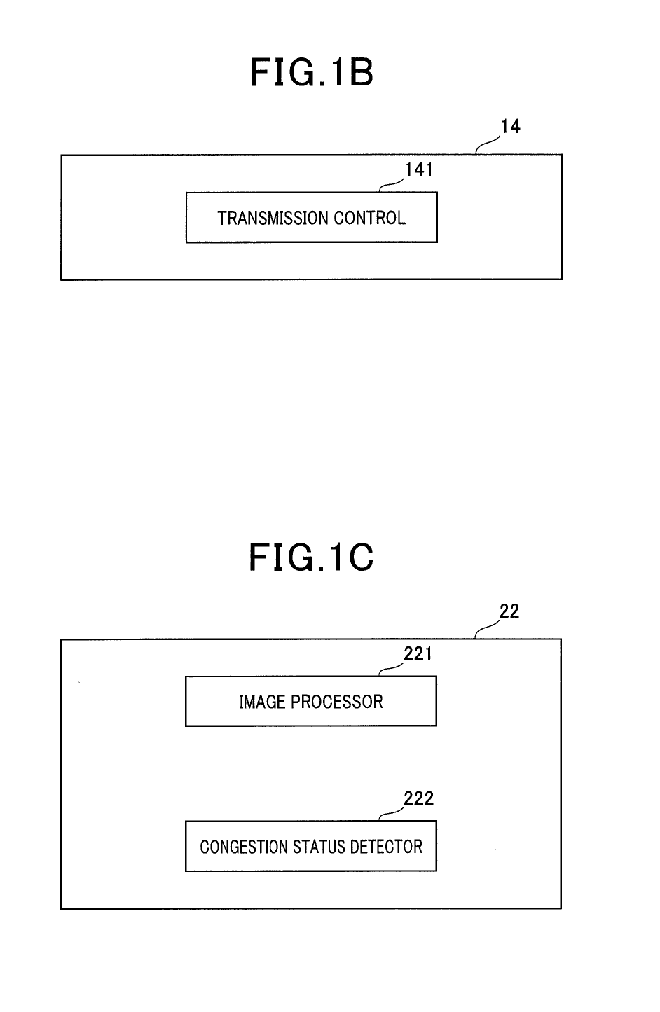

As shown in FIG. 1A, the vehicle driving assistance system of the present embodiment includes the vehicle-mounted apparatus 10 mounted in each vehicle, and the image information processing center 20 configured to receive information including an image from each vehicle-mounted apparatus 10 and perform a series of processes including predefined image processing.

The vehicle-mounted apparatus 10 includes an imaging unit 11, such as a charge-coupled device (CCD) camera. The imaging unit 11 is disposed in the passenger compartment of the subject vehicle, towards the vehicle front and close to the ceiling inside of the passenger compartment. A disposition angel of the imaging unit 11 or the like is adjusted so that the front end portion of the subject vehicle falls upon a portion of the captured image. This allows a distance from the subject vehicle to an object, such as a preceding vehicle or the like, to be calculated on the basis of a width of the front end portion of the subject vehicle. In addition, during traveling of the subject vehicle, the imaging unit 11 captures an image every predetermined time interval to output the captured image to a controller 14.

The controller 14 receives location information indicative of a location of the subject vehicle determined by a GPS receiver 12, steering angle information indicative of a steering angle of a steering wheel and brake pedal depression information via a vehicle interface (I/F) unit 13, in addition to the image from the imaging unit 11. The location information and the steering angle information are used as specific information in the image information processing center 20 to determine a collision risk with an object, where the location information is used to calculate a speed of the subject vehicle and the steering angle information is used to anticipate a traveling direction of the subject vehicle. Hence, the location information may be speed information, and the steering angle information may be information indicative of the magnitude of turn, such as a yaw rate or a lateral acceleration. The brake pedal depression information is used to determine whether or not a collision avoidance operation has been initiated by the driver to avoid a collision with an obstacle. Upon initiation of brake pedal depression, it may be determined that the collision risk is low.

The controller 14 includes an analog-to-digital converter (ADC) which converts an output image from the imaging unit 11 into a digital image, and an image memory which stores the converted image, as well as a microcomputer formed of CPU (not shown), ROM (not shown), and RAM (not shown) and others. The controller 14 transmits the digital image and the specific information to the image information processing center 20 via a vehicle-mounted radio 15 every predetermined time interval.

The vehicle-mounted radio 15, which serves as a vehicle-side communication unit, communicates with the image information processing center 20 via a communication network, such as a mobile telephone network. Congestion of the communication network is likely to cause the transmission of information including the digital image to be delayed. To reduce a data amount of image to be transmitted depending on a congestion status of the communication network, the controller 14 may apply a noise subtraction process and/or a data compression process to the digital image. A data amount of the noise subtracted image may be less than a data amount of the raw image (i.e., the unprocessed image). The data amount of image can further be reduced by applying the data compression process. The data compression process may be implemented in various manners, such as a difference calculation process of calculating a difference in data amount between the previously transmitted image and the current image to be transmitted or a discrete cosine transform (DCT). When the communication network is more congested, transmitting such a processed image having a reduced data amount may prevent the transmission delay from occurring.

FIG. 1B shows a functional block diagram of the controller 14. The controller 14 includes a transmission control 141 which is implemented by executing a prescribed computer program stored in the ROM or the like and allows the controller 14 to serve as a transmission control unit. The transmission control 141 is configured to select a data amount reduction process to be applied to the images to be transmitted and/or a transmission frequency (the inverse of transmission time interval) at which the processed images (images obtained by applying the selected data amount reduction process to the raw images) are to be transmitted as a function of the congestion status of the communication network, and apply the selected data amount reduction process to the images to be transmitted. This will be described later in more detail.

The display unit 16, which serves as a driving assistance unit, alerts the driver of the presence of an object. More specifically, when information indicative of the magnitude of a collision risk with an object received from the information processing center 20 shows that the subject vehicle is at high risk of colliding with the object, the display unit 16 alerts the driver by prominently displaying the object or by displaying an alert message. Displaying the object or the alert message may be accompanied with a voice alert message. Further, not only alerting the driver, but also automatically braking the vehicle may be performed to avoid the collision with the object.

The image information processing center 20 includes a communication unit 21 that communicates with the vehicle-mounted radio 15 of the vehicle-mounted apparatus 10, and a computer 22. The computer 22 performs image processing to extract from a received image an object for which a collision risk is determined. The computer 22 further determines the magnitude of a collision risk with the extracted object on the basis of the specific information including the location information and the steering angle information. The determination is to be transmitted to the vehicle-mounted apparatus 10 via the communication unit 21.

FIG. 1C shows a functional block diagram of the computer 22 of the image information processing center 20. The computer 22 includes an image processor 221 which is implemented by executing a prescribed computer program stored in the ROM or the like and allows the computer 22 to serve as an image processing unit, and a congestion status detector 222 which is also implemented by executing a prescribed computer program stored in the ROM or the like and allows the computer 22 to serve as a congestion status detection unit. The image processor 221 is configured to apply the predefined image processing to the image received from the subject vehicle. The congestion status detector 222 is configured to detect the congestion status of the communication network between the vehicle-mounted radio 15 and the center-side communication unit 21.

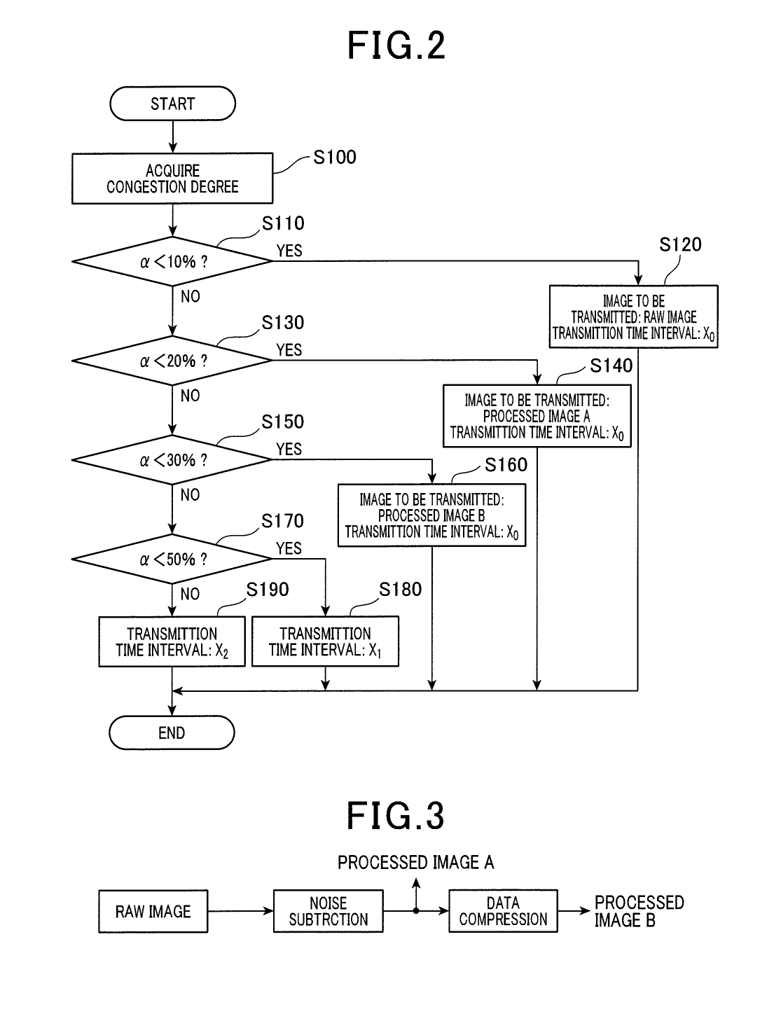

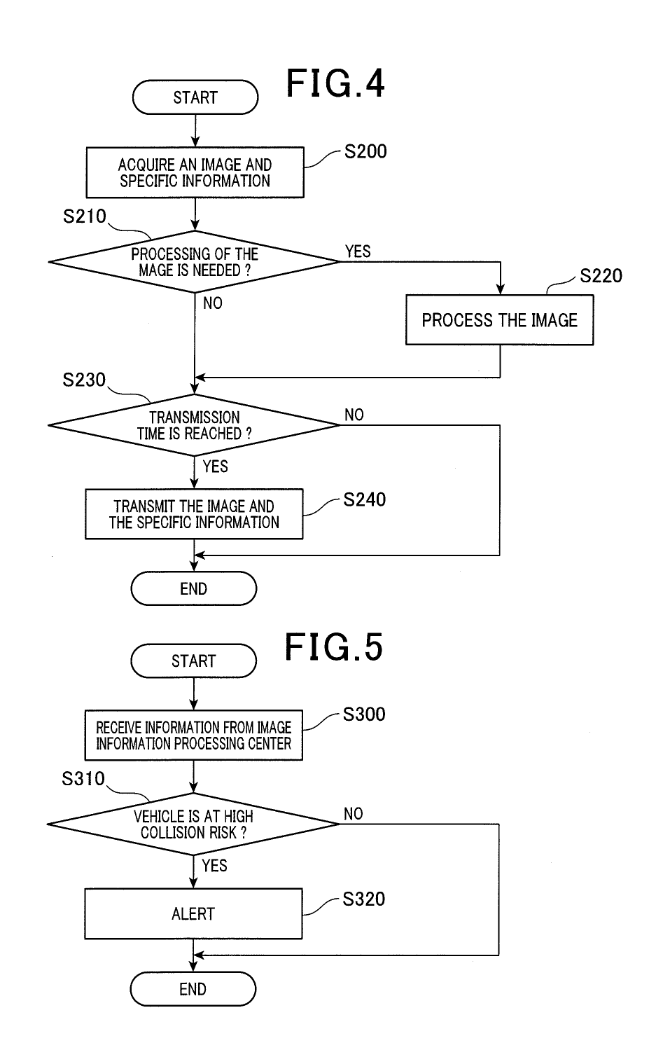

There will now be explained processes performed in the controller 14 of the vehicle-mounted apparatus 10 with reference to flowcharts of FIG. 2, FIG. 4, and FIG. 5.

FIG. 2 shows a flowchart of a process of selecting a data amount reduction process to be applied to the images to be transmitted and a transmission frequency at which the processed images (images obtained by applying the selected data amount reduction process to the raw images) are to be transmitted from the vehicle-mounted apparatus 10. This process will now be explained in more detail.

In step S100, a congestion degree α [alpha] of the communication network is acquired from the image information processing center 20. There are a few definitions of the congestion degree α, which will now be explained in a sequential order.

In a first definition, the congestion degree α is a ratio of a vacant time period to a predetermined time period (e.g., 100 ms), which is determined prior to transmitting the information including the image. The vacant time period is a time period in which a frequency band (or a carrier) to be used for transmitting the information is not used. As an example, for the predetermined time period of 100 ms, when the frequency band is occupied for a time period of 80 ms (i.e., the vacant time period is 20 ms), then the congestion degree α is 80%.

In a second definition, the congestion degree α is calculated on the basis of a rate of packet arrivals at the image information processing center 20. The information including the image is divided into a plurality of packets, and transmitted from the vehicle-mounted apparatus 10 of the subject vehicle to the image information processing center 20 in the form of packets. A ratio of the number of packets that have arrived at the image information processing center 20 to the number of packets transmitted from the vehicle-mounted apparatus 10 of the subject vehicle is correlated with the congestion status of the communication network.

For example, when the vehicle-mounted apparatus 10 of the subject vehicle has transmitted m packets within a predetermined time period (e.g., 100 ms) and received n acknowledgment signals (ACK signals) from the image information processing center 20, the congestion degree α may be calculated following the equation:

α(%)=100×(1−n/m).

In a third definition, the congestion degree α is calculated in the image information processing center 20 and received therefrom by the vehicle-mounted apparatus 10 of the subject vehicle. The image information processing center 20 can detect to what extent base stations of the communication network are congested by referencing a communication channel allocation list. The congestion degree α is calculated in the image information processing center 20 as a ratio of a number of vacant communication channels to a total number of communication channels, and is transmitted to the vehicle-mounted apparatus 10.

In the first embodiment, the congestion degree α is calculated in the image information processing center 20 following the third definition, and then transmitted therefrom to the vehicle-mounted apparatus 10.

Subsequently, it is determined in step S110 whether or not the congestion degree α is less than 10%. If it is determined in step S110 that the congestion degree α is less than 10%, then the process proceeds to step S120, where it is determined that raw images (i.e., unprocessed images) are to be transmitted at time intervals X0 (e.g., such that 33 images are transmitted every second). This is because, for the congestion degree α of less than 10%, the congestion degree a of the communication network may be very minimal and transmission of the information including the image may not be delayed.

If it is determined in step S110 that the congestion degree α is equal to or greater than 10%, then the process proceeds to step S130, where it is determined whether or not the congestion degree α is less than 20%. If it is determined in step S130 that the congestion degree α is less than 20%, then the process proceeds to step S140, where it is determined that processed images A are to be transmitted at predetermined time intervals X0. As shown in FIG. 3, the processed images A are noise-subtracted images obtained by subtracting noise from the respective raw images. In the case of the congestion degree a of less than 20%, but of 10% or greater than 10%, the congestion status of the communication network may be somewhat worse. This is why a data amount of each transmission image is reduced in step S140

If it is determined in step S130 that the congestion degree α is equal to or greater than 20%, then the process proceeds to step S150, where it is determined whether or not the congestion degree α is less than 30%. If it is determined in step S150 that the congestion degree α is less than 30%, then the process proceeds to step S160, where it is determined that processed images B are to be transmitted at predetermined time intervals X0. As shown in FIG. 3, the processed images B are compressed noise-subtracted images obtained by compressing the respective processed images A, which allows a data amount of each transmission image to be further reduced. Alternatively, the processed images B are compressed images obtained by compressing the respective raw images.

If it is determined in step S150 that the congestion degree α is equal to or greater than 30%, then the process proceeds to step S170, where it is determined whether or not the congestion degree α is less than 50%. If it is determined in step S170 that the congestion degree α is less than 50%, then the process proceeds to step S180, where it is determined that the raw images are to be transmitted at predetermined time intervals X1 (e.g., such that 10 images are transmitted every second). Increasing the transmission time interval to X1 allows a data amount of each transmission image to be much reduced. Alternatively, to further reduce a data amount of each image to be transmitted, it may be determined that the processed images A or the processed imaged B are to be transmitted at predetermined time intervals X1. If it is determined in step S170 that the congestion degree α is equal to or greater than 50%, then the process proceeds to step S190, where it is determined that the raw images are to be transmitted at predetermined time intervals X2 (e.g., such that 5 images are transmitted every second). The operation in step S190 is performed because the congestion status of the communication network has become much worse. Alternatively, as in step S180, to further reduce a data amount of each image to be transmitted, it may be determined that the processed images A or the processed imaged B are to be transmitted at predetermined time intervals X2.

The above process shown in the flowchart of FIG. 2 allows a suitable data amount reduction process to be applied to the images to be transmitted and a suitable transmission frequency at which the processed images are to be transmitted to be determined as a function of the congestion status of the communication network. Although the specific criteria are used in steps S110, S130, S150, and S170, other criteria may be used to determine the congestion status of the communication network. In addition, the whole range of congestion degree of the communication network may be finer or coarser partitioned.

FIG. 4 shows a flowchart of a process performed in the vehicle-mounted apparatus 10, where the vehicle-mounted apparatus 10 transmits the information including the image to the image information processing center 20 in accordance with a determination of the process of FIG. 2.

First, in step S200, the controller 14 acquires the images (raw images) and the specific information via the imaging unit 11, the GPS receiver 12, the vehicle interface unit 13 and others at time intervals corresponding to a minimum transmission time interval. In step S210, it is determined whether or not processing of the images is needed to reduce their data amounts. This operation is performed on the basis of a determination of the process of FIG. 2. More specifically, if it is determined that the raw images are to be transmitted, then it is determined that no processing of the raw images is needed. If it is determined that the processed images A or the processed images B are to be transmitted, then it is determined that corresponding processing (noise subtraction and/or data compression) of the raw images is needed. In step 220, the corresponding processing of the raw images is performed to acquire the processed images A or the processed images B.

In step S230, on the basis of the transmission time interval (or the transmission frequency) determined in the process of FIG. 2, it is determined whether or not a transmission time is reached. If a transmission time is reached, then the raw or processed image and the specific information are transmitted to the image information processing center 20 in step S240. If a transmission time is not reached yet, then the process is ended.

FIG. 5 shows a flowchart of a process in which the vehicle-mounted apparatus 10 receives information indicative of the magnitude of a collision risk with an object based on an outcome of the image processing from the image information processing center 20, and alerts the driver of the presence of the object when the received information shows that the subject vehicle is at high risk of colliding with the object.

In step S300, the vehicle-mounted apparatus 10 receives information indicative of the magnitude of a collision risk with an object based on an outcome of the image processing from the image information processing center 20. This information includes specific information for specifying an object in the image from the vehicle-mounted apparatus 10. In the presence of a plurality of objects with which the subject vehicle is at high risk of colliding, the information received from the image information processing center 20 includes information about the respective objects.

In step S310, on the basis of the information received from the image information processing center 20, the vehicle-mounted apparatus 10 determines whether or not the subject vehicle is at high risk of colliding with the object. If it is determined that the subject vehicle is at high risk of colliding with the object, then the process proceeds to step S320, where the vehicle-mounted apparatus 10 alerts the driver of the presence of the object through the display unit 16.

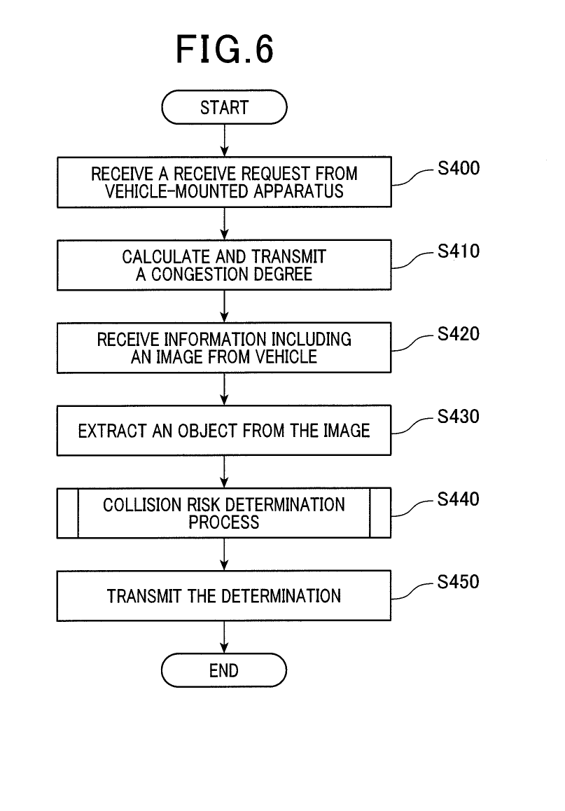

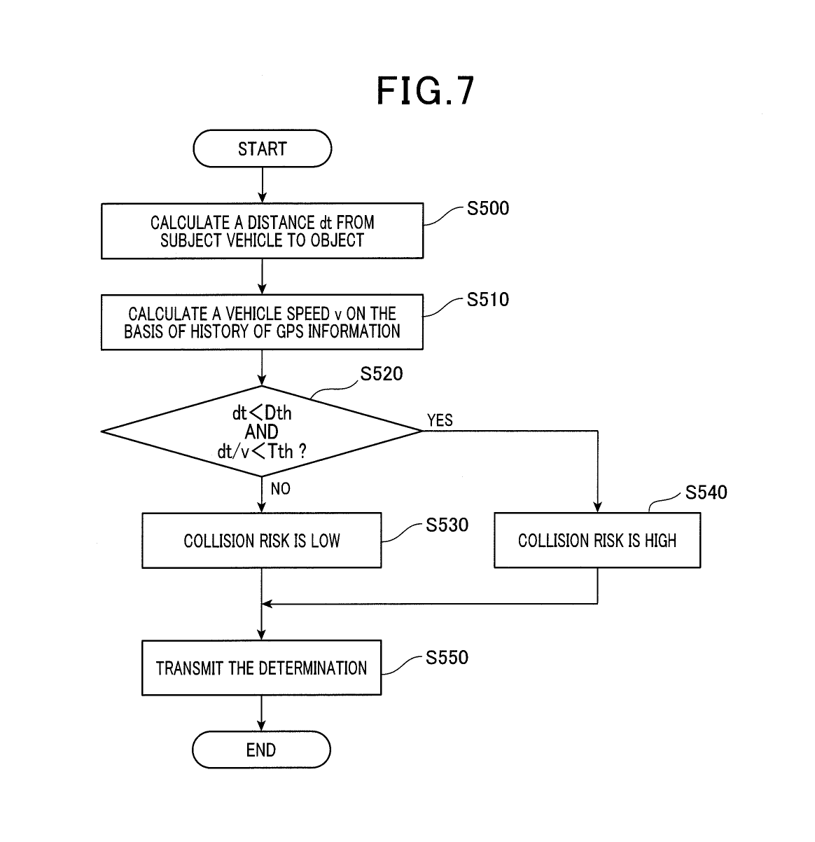

There will now be explained a process performed in the image information processing center 20 with reference to flowcharts of FIG. 6 and FIG. 7.

FIG. 6 shows a flowchart of a process in which the image information processing center 20 receives the information including the image from the vehicle-mounted apparatus 10, determines the magnitude of a collision risk with an object by processing the image included in the received information, and transmits the determination to the vehicle-mounted apparatus 10.

First, in step S400, the image information processing center 20 receives from the vehicle-mounted apparatus 10 a request to receive information including an image (hereinafter referred to as a receive request). That is, the vehicle-mounted apparatus 10 issues the request to the image information processing center 20 prior to transmitting the information including the image. Subsequently, in step S410, the image information processing center 20 calculates a congestion degree α on the basis of a list of vacant communication channels to transmit the congestion degree α to the vehicle-mounted apparatus 10. This allows the vehicle-mounted apparatus 10 to acquire the congestion degree α that is indicative of the congestion status of the communication network.

In step S420, the image information processing center 20 receives information including the image and the specific information from the vehicle-mounted apparatus 10. Subsequently, in step S430, the image information processing center 20 processes the received image to extract an object for which a collision risk is determined. In this image processing, a portion of the received image indicative of a vehicle other than the subject vehicle or a pedestrian may be extracted from the entire image through well-known pattern matching or the like, or an object in the image may be recognized by using a technique for extracting or describing image features, such as a scale-invariant feature transform (SIFT).

Preferably, in step S430, the image information processing center 20 may narrow down a portion of the image in which an object for which a collision risk is determined may exist by using the steering angle information as the specific information prior to extracting the object from the image, and may apply the image processing to the narrowed portion of the image. Alternatively, the image information processing center 20 may exclude an object that may not exist in the traveling direction of the subject vehicle on the basis of the steering angle information from the objects extracted through the image processing and discuss only the objects other than the excluded one in the subsequent process. This can decrease a processing load and increase a processing speed in the image information processing center 20.

In general, the extraction and recognition of the object in the image for which a collision risk is determined requires a great amount of calculation. However, a high-performance computer is easier to install in the image information processing center 20 than in the vehicle-mounted apparatus 10. Hence the above image processing is allowed to be performed at a very high speed. In addition, the above configuration facilitates incorporation of a new and effective technique into the image processing technique in use.

In step S440, a collision risk determination process is performed. In the presence of a plurality of objects extracted from the image in step S430, a collision risk is determined for each extracted object. The collision risk determination process will be explained later in more detail with reference to FIG. 7.

Finally, in step S450, the image information processing center transmits the determination made in step S440 to the vehicle-mounted apparatus 10.

The collision risk determination process will now be explained with reference to a flowchart of FIG. 7.

First, in step S500, a distance dt from the subject vehicle to the object is calculated as follows.

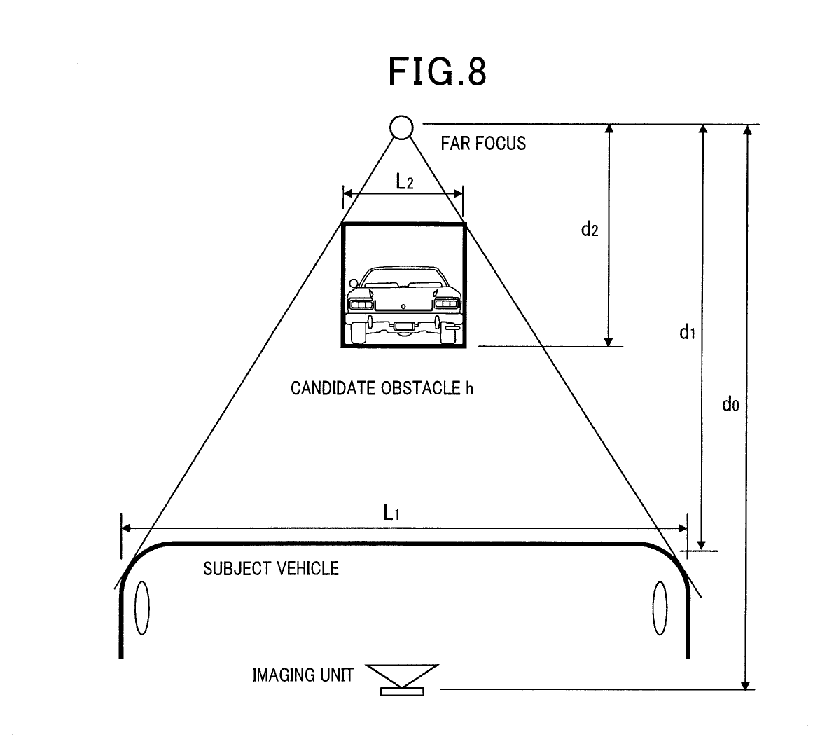

As shown in FIG. 8, when an object for which a collision risk is determined is a vehicle traveling ahead of the subject vehicle (hereinafter referred to as a preceding vehicle), a width L2 of the preceding vehicle is known (e.g., 1.5 m for a mini-vehicle, 1.8 m for a mid-size vehicle). A width L1 of the subject vehicle may also be known to the image information processing center 20 by pre-registering the width L1 in the image information processing center 20 or by transmitting the specific information including the width L1 to the image information processing center 20.

As can be seen from FIG. 8, the following equation is satisfied.

d2/d1=L2/L1 (1)

A distance dt from the subject vehicle to the object can be expressed by the following equation.

dt=d1−d2=(1−L2/L1)d1 (2)

In the above equations, the distance d1 from the front end of the subject vehicle to a far focus is obtained by subtracting a distance from the imaging unit 11 to the front end of the subject vehicle from a distance d0 from the imaging unit 11 to the far focus. The distance d0 from the imaging unit 11 to the far focus may be determined by experiment. The distance from the imaging unit 11 to the front end of the subject vehicle may also be known in advance. Therefore, the distance d1 from the front end of the subject vehicle to the far focus is also known, which allows the distance dt from the front end of the subject vehicle to the object to be calculated according to the equation (2). When the subject vehicle is equipped with a radar unit, a distance from the subject vehicle to an obstacle detected ahead of the subject vehicle may be transmitted to the image information processing center 20. The transmitted distance may be used as a distance from the subject vehicle to the object.

Subsequently, in step S510, a speed v of the subject vehicle is calculated on the basis of a history of the GPS location information received from the vehicle-mounted apparatus 10 as the specific information. In step S520, it is determined whether or not the distance dt from the subject vehicle to the object is less than a distance threshold Dth, i.e., dt<Dth, and the distance dt divided by the speed v of the subject vehicle is less than a time threshold Tth, i.e., dt/v<Tth. If it is determined in step S520 that dt<Dth and dt/v<Tth, then the process proceeds to step S540, where it is determined that the subject vehicle is at high risk of colliding with the object. If it is determined in step S520 that the distance dt from the subject vehicle to the object is equal to or greater than the distance threshold Dth, i.e., dt≧Dth, or the distance dt divided by the speed v of the subject vehicle is equal to or greater than the time threshold Tth, i.e., dt/v≧Tth, then the process proceeds to step S530, where it is determined that the subject vehicle is at low risk of colliding with the object.

When it is recognized from the brake pedal depression information as the specific information that the driver of the subject vehicle has started to depress the brake pedal, it may be determined that the subject vehicle is at low risk of colliding with the object even when it is determined in step S520 that dt<Dth and dt/v<Tth.

Alternatively, in step S520, a time until collision is calculated. The time until collision is given by the distance dt from the subject vehicle to the object divided by the speed v of the subject vehicle relative to the object, where a speed of the object can be determined from a change of location of the object on the image. It may then be determined whether or not the time until collision is less than the time threshold Tth.

In step S550, the determination made in step S530 or S540 is transmitted to the vehicle-mounted apparatus 10.

In the vehicle driving system of the present embodiment described above, the image processing is performed not in the vehicle-mounted apparatus 10, but in the image information processing center 20 outside of the subject vehicle. With this configuration, the vehicle-mounted apparatus 10 needs only be able to transmit information including an image and alert the driver of the subject vehicle of a collision risk on the basis of information received from the image information processing center 20. In addition, a high performance computer is easy to install in the image information processing center 20. Use of the high performance computer to perform the image processing may lead to rapid and accurate detection of an object that is likely to collide with the subject vehicle.

That is, without using a high performance computer in the vehicle-mounted apparatus 10, practical driving assistance becomes possible.

### Second Embodiment

There will now be explained a second embodiment of the present invention with reference to the accompanied drawings. Only differences of the second embodiment from the first embodiment will be explained.

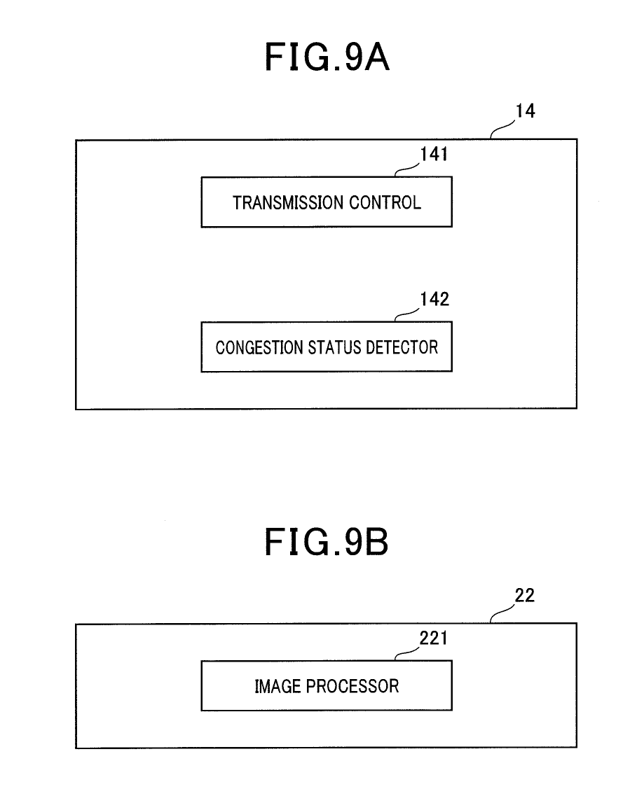

FIG. 9A shows a functional block diagram of the controller 14. The controller 14 includes a transmission control 141 which is implemented by executing a prescribed computer program stored in the ROM or the like and allows the controller 14 to serve as a transmission control unit, and a congestion status detector 142 which is also implemented by executing a prescribed computer program stored in the ROM or the like and allows the controller 14 to serve as a congestion status detection unit. The transmission control 141 is configured to select a data amount reduction process to be applied to the images to be transmitted and/or a transmission frequency at which the processed images (images obtained by applying the selected data amount reduction process to the raw images) are to be transmitted as a function of the congestion status of the communication network, and apply the selected data amount reduction process to the images to be transmitted. The congestion status detector 142 is configured to detect the congestion status of the communication network between the vehicle-mounted radio 15 and the center-side communication unit 21.

FIG. 9B shows a functional block diagram of the computer 22 of the image information processing center 20. The computer 22 includes an image processor 221 which is implemented by executing a prescribed computer program stored in the ROM or the like and allows the computer 22 to serve as an image processing unit. The image processor 221 is configured to apply the predefined image processing to the image received from the subject vehicle.

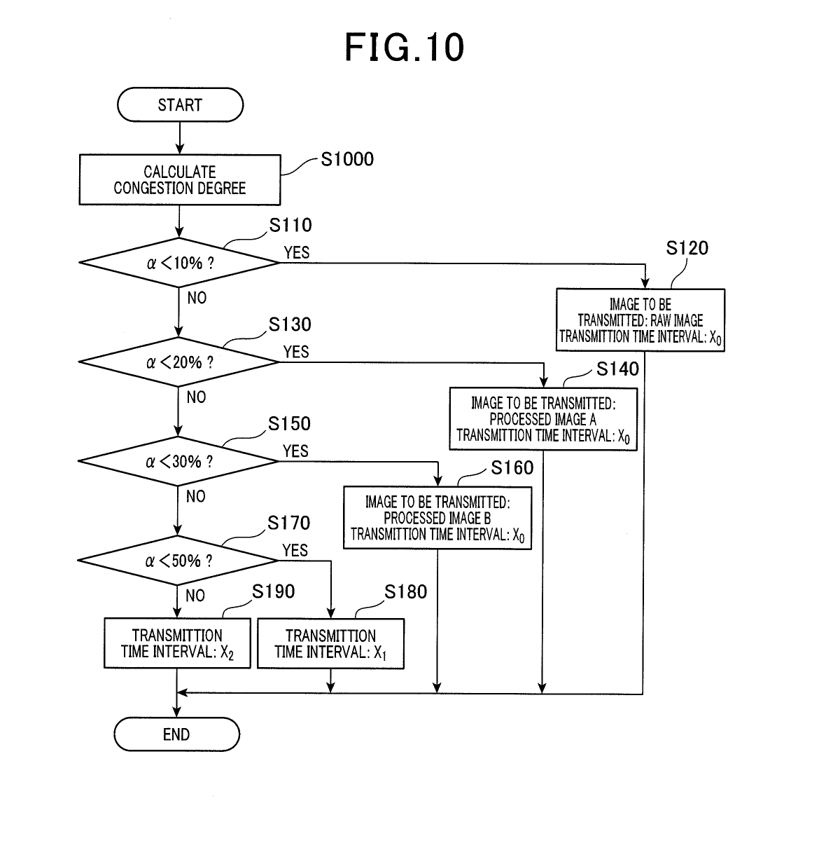

FIG. 10 shows a flowchart of a process of selecting a data amount reduction process to be applied to the images to be transmitted and a transmission frequency at which the processed images (images obtained by applying the selected data amount reduction process to the raw images) are to be transmitted from the vehicle-mounted apparatus 10. In the present embodiment, the congestion degree α of the communication network is calculated in the vehicle-mounted apparatus 10 in accordance with the first or second definition of the congestion degree α. The process of FIG. 10 is similar to the process of FIG. 2 except that, in step S1000, the congestion degree α of the communication network is calculated in the vehicle-mounted apparatus 10. Subsequent operations of the process of FIG. 10 are same as the operations of the flowchart of FIG. 2.

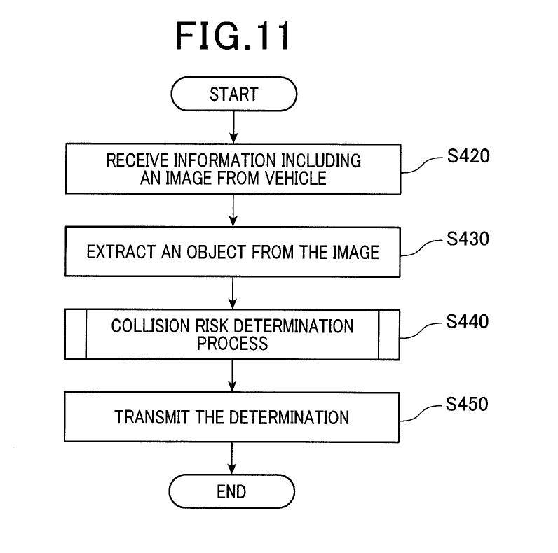

FIG. 11 shows a flowchart of a process in which the image information processing center 20 receives the information including the image from the vehicle-mounted apparatus 10, determines the magnitude of a collision risk with an object by applying the image processing to the image included in the received information, and transmits the determination to the vehicle-mounted apparatus 10. In the present embodiment, the process of FIG. 11 is similar to the process of FIG. 6 except that the operations in steps S400, S410 are not performed.

The second embodiment is similar to the first embodiment except that, in the second embodiment, the congestion degree α of the communication network is calculated in the vehicle-mounted apparatus 10. Therefore, the second embodiment can furnish similar benefits as in the first embodiment. With the configuration of the second embodiment, the vehicle-mounted apparatus 10 needs only be able to calculate the congestion degree α of the communication network, transmit information including an image, and alert the driver of the subject vehicle of a collision risk on the basis of information received from the image information processing center 20.

### Other Embodiments

There will now be explained other embodiments that may be devised without departing from the spirit and scope of the present invention. Only differences from the above embodiments will be explained.

In the above embodiments, the distance threshold Ddth and the time threshold Tth are constant in time. Alternatively, since a communication time required for the vehicle-mounted apparatus 10 and the image information processing center 20 to communicate with each other may vary with time depending on the congestion status of the communication network, the distance threshold Ddth and the time threshold Tth may be changed over time as a function of the congestion status of the communication network. More specifically, the distance threshold Ddth and the time threshold Tth are increased as the congestion status of the communication network worsens. This can prevent the timing of alerting the driver from being delayed even when the communication time between the vehicle-mounted apparatus 10 and the image information processing center 20 is somewhat increased.

What is claimed is:

1. A vehicle driving assistance system comprising:
an imaging unit mounted in a vehicle and configured to capture an image of surroundings of the vehicle;
a vehicle-side communication unit mounted in the vehicle and configured to transmit information including the image captured by the imaging unit to an information processing center outside of the vehicle;
an image processing unit included in the information processing center and configured to apply predefined image processing to the image received from the vehicle;
a center-side communication unit included in the information processing center and configured to transmit information indicative of an outcome of the image processing by the image processing unit to the vehicle; and
a driving assistance unit mounted in the vehicle and configured to perform operations for assisting in driving the vehicle on the basis of the information indicative of the outcome of the image processing by the image processing unit.

2. The system of claim 1, further comprising:
a congestion status detection unit included in the information processing center and configured to detect a congestion status of a communication network between the vehicle-side communication unit and the center-side communication unit; and
a transmission control unit mounted in the vehicle and configured to select a data amount reduction process to be applied to the information to be transmitted by the vehicle-side communication unit and a transmission frequency at which the processed information is to be transmitted as a function of the congestion status of the communication network detected by the congestion status detection unit.

3. The system of claim 2, wherein the transmission control unit is configured to select a data amount reduction process to be applied to the information to be transmitted by the vehicle-side communication unit so that a data amount of the image included in the information is decreased with worsening congestion status.

4. The system of claim 3, wherein the data amount of the image included in the information is decreased by subtracting noise from the image included in the information.

5. The system of claim 3, wherein the data amount of the image included in the information is decreased by compressing the image included in the information.

6. The system of claim 3, wherein the data amount of the image included in the information is decreased by subtracting noise from the image included in the information and then compressing the noise subtracted image.

7. The system of claim 2, wherein the transmission control unit is configured to determine the transmission frequency of the information to be transmitted by the vehicle-side communication unit so that the transmission frequency is decreased with worsening congestion status.

8. The system of claim 1, further comprising:
a congestion status detection unit mounted in the vehicle and configured to detect a congestion status of a communication network between the vehicle-side communication unit and the center-side communication unit; and
a transmission control unit mounted in the vehicle and configured to select a data amount reduction process to be applied to the information to be transmitted by the vehicle-side communication unit and a transmission frequency at which the processed information is to be transmitted as a function of the congestion status of the communication network detected by the congestion status detection unit.

9. The system of claim 8, wherein the transmission control unit is configured to select a data amount reduction process to be applied to the information to be transmitted by the vehicle-side communication unit so that a data amount of the image included in the information is decreased with worsening congestion status.

10. The system of claim 9, wherein the data amount of the image included in the information is decreased by subtracting noise from the image included in the information.

11. The system of claim 9, wherein the data amount of the image included in the information is decreased by compressing the image included in the information.

12. The system of claim 9, wherein the data amount of the image included in the information is decreased by subtracting noise from the image included in the information and then compressing the noise subtracted image.

13. The system of claim 8, wherein the transmission control unit is configured to determine the transmission frequency of the information to be transmitted by the vehicle-side communication unit so that the transmission frequency is decreased with worsening congestion status.

14. The system of claim 1, wherein
the information to be transmitted from the vehicle-side communication unit to the information processing center further includes information indicative of a driving condition of the vehicle,
the image processing unit is configured to, on the basis of the image and the driving condition of the vehicle received from the vehicle, specify an obstacle that is likely to collide with the vehicle, and determine whether a collision risk with the obstacle is high or low, and
the driving assistance unit is configured to, when it is determined that the collision risk with the obstacle is high, assist in driving the vehicle to avoid a collision with the obstacle.

15. The system of claim 14, further comprising:
a congestion status detection unit included in the information processing center and configured to detect a congestion status of a communication network between the vehicle-side communication unit and the center-side communication unit,
wherein the image processing unit is configured to change a criterion for determining whether the collision risk with the object is high or low as a function of the congestion status of the communication network detected by the congestion status detection unit.
